(19) United States
(12) Patent Application Publication
(10) Pub. No.: US 2006/0022929 A1
(43) Pub. Date: Feb. 2, 2006

(54) Liquid crystal display device and driver circuit therefor

(75) Inventors: Yoshiharu Hashimoto, Kanagawa (JP); Masayuki Kumeta, Kanagawa (JP); Kouji Matsuura, Kanagawa (JP)

Correspondence Address: YOUNG & THOMPSON, 745 SOUTH 23RD STREET, 2ND FLOOR, ARLINGTON, VA, 22202, US

(73) Assignee: NEC Electronics Corporation, Kanagawa (JP)

(21) Appl. No.: 11/192,365

(22) Filed: Jul. 29, 2005

(30) Foreign Application Priority Data
Jul. 29, 2004 (JP) 2004-221220

(51) Int. Cl. G09G 3/36

(52) U.S. Cl. 345/96

(57) ABSTRACT

When the display presented by a liquid crystal display device is a standby screen, a power-conservation signal is input from a CPU and a binary mode and partial mode are discriminated from the signal. When the binary mode is in effect, V-line inversion drive is adopted instead of dot inversion drive used in a normal display mode, thereby reducing power consumption. If the binary mode is not in effect at the time of the partial mode, a display area is subjected to dot inversion drive and a non-display area to V-line inversion drive. If the binary mode is in effect at the time of the partial mode, display and non-display areas are subjected to V-line inversion drive at different frequencies.

### FIELD OF THE INVENTION

This invention relates to a display device, particularly a liquid crystal display device, and, more particularly, to a technique for reducing power consumption in an active matrix liquid crystal display device.

### BACKGROUND OF THE INVENTION

Liquid crystal display devices are frequently employed in the displays of various electronic devices such as mobile telephones owing to their low power consumption, light weight and thin design. Examples of liquid crystal display devices are those of simple matrix type and those of active matrix-type (Active Matrix Liquid Crystal Display, or AMLCD) that use active elements such as TFTs (Thin Film Transistors) as the pixels. Known methods of driving an AMLCD include frame inversion, H-line inversion (line inversion), V-line inversion (column inversion) and dot inversion. Among these driving modes, frame inversion is disadvantageous in that flicker is conspicuous, and V-line inversion is also disadvantageous in that vertical stripes readily appear, although flicker is not readily noticeable. These methods of drive, therefore, normally are not used. For this reason, H-line inversion, in which flicker is not readily apparent, is used in small-size liquid crystal display devices, and dot inversion, which is almost entirely free of the occurrence of flicker, is used in large-size liquid crystal display devices.

While dot inversion excels in terms of cross-talk and flicker, a drawback is large consumption of power. In order to suppress the consumption of power, the specification of Japanese Patent Publication No. JP2002-91400A (referred to as “Patent Document 1” below) proposes providing movement detecting means for detecting movement of an input image signal and varying at least one among driving frequency, driving mode and backlighting method adaptively in accordance with the output of the movement detecting means. According to Patent Document 1, raising the driving frequency is effective in that it solves the problem of sluggish motion that arises when a moving image is displayed. However there is an increase in power consumption when a still image is displayed. In a case where intermittent light emission is adopted as the method of backlighting, this is effective in that it solves the problem of sluggish motion when a moving image is displayed. However, there is an increase in flicker in the case of a still-image display. Patent Document 1 proposes making the driving frequency conform to a synchronizing signal and adopting dot inversion as the driving mode in the case of a still image, and making the driving frequency higher than that of the synchronizing signal and adopting V-line inversion as the driving mode in the case of a moving image. As a result, control that gives priority to suppression of cross-talk and flicker is performed in the case of a still image, and control that gives priority to a reduction in power consumption is performed in the case of a moving image. Further, it is proposed that continuous lighting be adopted for backlighting in the case of a still image and intermittent lighting in the case of a moving image.

With a transmissive-type liquid crystal display device, the display screen appears dark in an environment that is brighter than the backlighting, as in a case where the display is viewed in sunlight. With a reflective-type liquid crystal display device, the display screen will be dark if the device is used in a dark location. Consequently, semi-transmissive liquid crystal displays that can both transmit and reflect often are used as the displays in portable electronic devices. In the case of such a semi-transmissive liquid crystal display device, flicker becomes noticeable under sunlight even if it is attempted to suppress flicker by adopting V-line inversion drive and intermittent light emission for backlighting as proposed in Patent Document 1.

In the case of a display for a portable electronic device such as a mobile telephone, reducing power consumption is important and a technique that can reduce power consumption of a standby screen is particularly desired. The art set forth in Patent Document 1 only controls the driving frequency, driving mode and backlighting method by detecting still and moving images and therefore is not effective in reducing the power consumption of a standby screen, which often is a still image. In particular, a standby display often provides a partial display in which only a part of the display device is used in presenting a display. Since Patent Document 1 does not take such partial displays into account, it is not always effective in reducing power consumption.

### SUMMARY OF THE DISCLOSURE

Accordingly, there is much to be desired in the art for a display device, particularly a liquid crystal display device and driver circuit therefor that make it possible to reduce the power consumption of the device and, in particular, the power consumed by a standby screen in the display device of a portable electronic device.

According to an aspect of the present invention, there is provided a display device, particularly liquid crystal display device, having pixels disposed at the intersections of a plurality of scanning lines and a plurality of data lines and a driving method therefore, characterized in that at least one of a driving mode and driving frequency can be changed in response to a power-conservation signal that is input when the device is in a mode different from a normal display mode. Specifically, the power-conservation signal is a signal indicative of a binary mode. In the binary mode, the data lines are driven according to a first driving mode by selecting one voltage from binary voltages conforming to the most significant bit of an n-bit digital image signal. In the normal display mode, the data lines are driven according to a second driving mode by selecting one voltage from voltages of 2 n values conforming to all bits of the n-bit digital image signal. Alternatively, the power-conservation signal is indicative of a partial mode. In a partial non-display area in the partial mode, data lines are driven according to a first driving mode by an image-OFF voltage. In a partial display area in the partial mode, the data lines are driven according to the first driving mode when the binary mode is in effect, and the data lines are driven according to a second driving mode by selecting one voltage from voltages of 2 n values conforming to n bits of the digital image signal when the binary mode is not in effect.

The first driving mode may be the V-line inversion driving mode, and the second driving mode may be the dot inversion driving mode. In this case, it may be so arranged that the frame frequency in the first driving mode is set to be lower than the frame frequency in the second driving mode. Alternatively, the first driving mode is made the frame inversion driving mode and the second driving mode is made the H-line inversion driving mode.

Further, according to another aspect of the present invention, there is provided a driver circuit of a display device, particularly a liquid crystal display device, having pixels disposed at the intersections of a plurality of scanning lines and a plurality of data lines. The driver circuit is characterized by having at least a gamma generating circuit for generating a plurality of grayscale voltages by performing voltage division between a minimum applied voltage and a maximum applied voltage so as to conform to a gamma characteristic, and a resistor-string circuit for generating a plurality of grayscale voltages other than the minimum applied voltage and maximum applied voltage of the gamma generating circuit, wherein a value of current that flows into the resistor-string circuit can be changed in response to a power-conservation signal that is input when the device is in a mode different from a normal display mode. For example, the driver circuit includes a positive-polarity D/A converting circuit for supplying a positive-polarity image signal to the data line using as a reference the voltage of a liquid crystal common electrode corresponding to a digital image signal; a negative-polarity D/A converting circuit for supplying a negative-polarity image signal to the data line; and a changeover circuit constituted by a plurality of switches for selecting the positive- or negative-polarity signal, and a capacitor. In a first time period, a data line to which the positive-polarity image signal has been applied and one end of the capacitor are connected by turning on switches to thereby store an electric charge of positive polarity, and a data line to which the negative-polarity image signal has been applied and the other end of the capacitor are connected by turning on switches to thereby store an electric charge of negative polarity. In a second time period, the terminals of the capacitor are interchanged. The interchanging of the capacitor terminals is performed every frame at the time of V-line inversion drive and every n scanning lines at the time of n-dot inversion drive in accordance with a power-conservation signal that is input when the device is in a mode different from a normal display mode.

In a further aspect of the present invention, there is provided a method for driving a display device.

The meritorious effects of the present invention are summarized as follows.

The present invention is such that in the normal display mode, drive is performed by dot inversion. However, in the binary mode or partial mode, which is a mode in which the power-conservation signal is input, V-line inversion drive is performed so that power consumption can be reduced. Although V-line inversion drive is disadvantageous in terms of vertical stripes and flicker, a saturated region is utilized in the binary mode and hence there is almost no occurrence of vertical stripes and flicker. As a result, power consumed by a display on a standby screen can be greatly reduced.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram of a liquid crystal display device according to the present invention;

FIG. 2 is a flowchart for controlling the driving mode according to an embodiment of the present invention;

FIGS. 3A and 3B are diagrams illustrating the polarities of pixels at the time of dot inversion drive and V-line inversion drive of a liquid crystal display device;

FIG. 4 is a diagram of the transmittance vs. voltage characteristic of a liquid crystal;

FIG. 5 is a circuit diagram of a data-line driver circuit;

FIG. 6 is a circuit diagram of a D/A converting circuit in the data-line driver circuit;

FIG. 7 is a timing chart of the data-line driver circuit;

FIGS. 8A, 8B, 8C and 8D illustrate the operation of a changeover circuit for changing over the image signal output of the data-line driver circuit;

FIGS. 9A and 9B are diagrams illustrating the details of a positive-polarity gamma generating circuit and negative-polarity gamma generating circuit;

FIG. 10 is a flowchart for deciding a driving mode and driving frequency in a binary mode according to the present invention;

FIG. 11 illustrates a display screen of a liquid crystal display device in a partial mode;

FIG. 12 is a flowchart for deciding a driving mode and driving frequency in a partial mode according to the present invention;

FIG. 13 is a timing chart of the partial mode according to the present invention;

FIG. 14 is a flowchart for deciding a driving mode and driving frequency in still- and movie-image modes according to the present invention; and

FIGS. 15A, 15B, 15C and 15D are diagrams illustrating the polarities of pixels at the time of frame inversion drive and H-line inversion drive of a liquid crystal display device.

### PREFERRED EMBODIMENTS OF THE INVENTION

Embodiments of the present invention will now be described in detail with reference to the drawings.

### First Embodiment

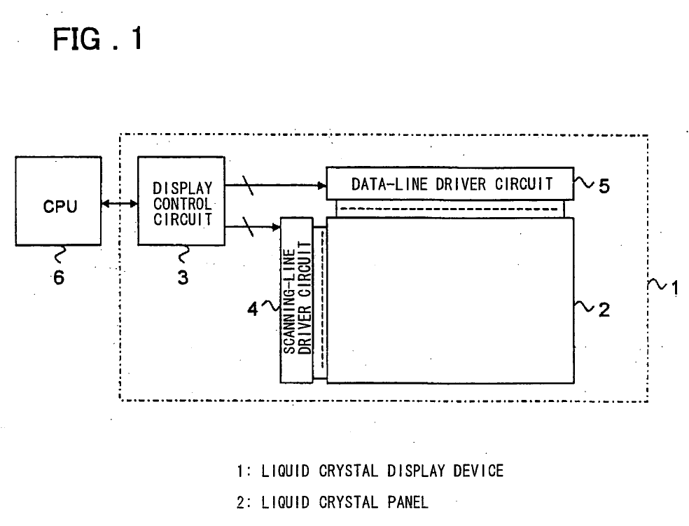

FIG. 1 is a block diagram illustrating an example of a liquid crystal display device 1 according to a first embodiment of the present invention. The liquid crystal display device comprises a liquid crystal panel 2 having a number of pixels (not shown) disposed at the intersections of a plurality of scanning lines and a plurality of data lines; a scanning-line driver circuit 4 for driving the scanning lines; a data-line driver circuit 5 for driving the data lines; and a display control circuit 3 for controlling the scanning-line driver circuit 4 and data-line driver circuit 5. The liquid crystal display device 1 further includes a power supply circuit, not shown. A control signal that includes an image signal input from a CPU 6 of a portable electronic device such as a mobile telephone enters the display control circuit 3, which proceeds to display an image on the liquid crystal panel based upon the control signal. The control signal further includes a power-conservation signal, as will be described later. It is so arranged that at least one of a driving mode and driving frequency in the scanning-line driver circuit 4 and data-line driver circuit 5 is controlled in response the power-conservation signal.

In the first embodiment, it is assumed that the liquid crystal display device 1 is employed in the display unit of a mobile telephone. A mobile telephone can operate in a sleep or standby state. In such a state the telephone is receiving radio waves but is not communicating. In order to conserve power in the standby state, there are three stages of operation. In the first stage, backlighting is dimmed if a prescribed period of time passes without a key being pressed. In a second stage, backlighting is turned off. In a third stage, the display screen changes over to a standby screen, such as a display of time. In order to conserve power when the mobile telephone is in the standby state according to this embodiment, the CPU 6 outputs a signal that places the display device in a binary mode, namely a mode in which a 64-level display is reduced to a two-level display. This signal is input to the display control circuit 3 as the “power-conservation signal” that is a characterizing feature of the present invention.

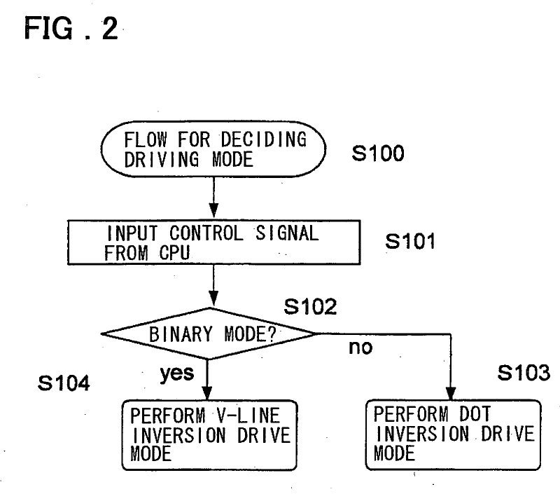

FIG. 2 is a flowchart (S100) for controlling the driving mode of the liquid crystal display device according to the first embodiment. When the control signal from the CPU 6 is input to the display device (S101), the control signal is discriminated (S102). If the result of discrimination is that the mode is not the binary mode, i.e., that the effective mode is the normal display mode in which the power-conservation signal is absent, then dot inversion drive is performed (S103). On the other hand, if the mode is the binary mode in which the control signal contains the power-conservation signal, then V-line inversion drive (also referred to as “column inversion drive”) is performed (S104).

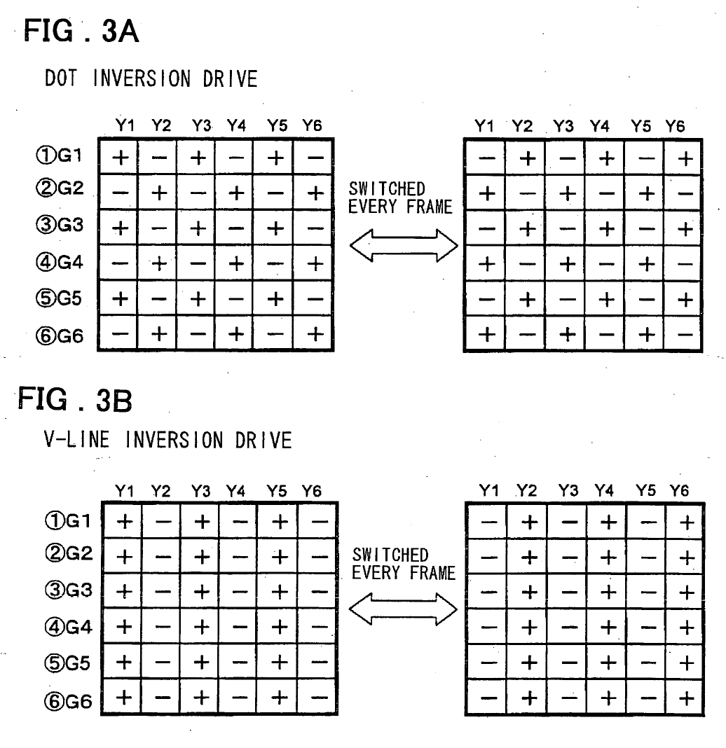

As shown at FIG. 3A, dot inversion drive is a mode (or process) of performing drive in such a manner that the polarities of neighboring pixels will be different from each other. The inverting of polarity every scanning line is referred to as one-dot inversion drive, the inverting of polarity every two scanning lines is referred to as two-dot inversion drive, and the inverting of polarity every n scanning lines is referred to as n-dot inversion drive. If the number of all scanning lines of the display device is m, then n is assumed to be a number of from 1 to m/2. Further, V-line inversion drive is drive in which polarity is not inverted over a period of m scanning lines. This is a method of performing drive in such a manner that the polarities of neighboring pixels in the horizontal direction will be different from each other, as illustrated at FIG. 3B.

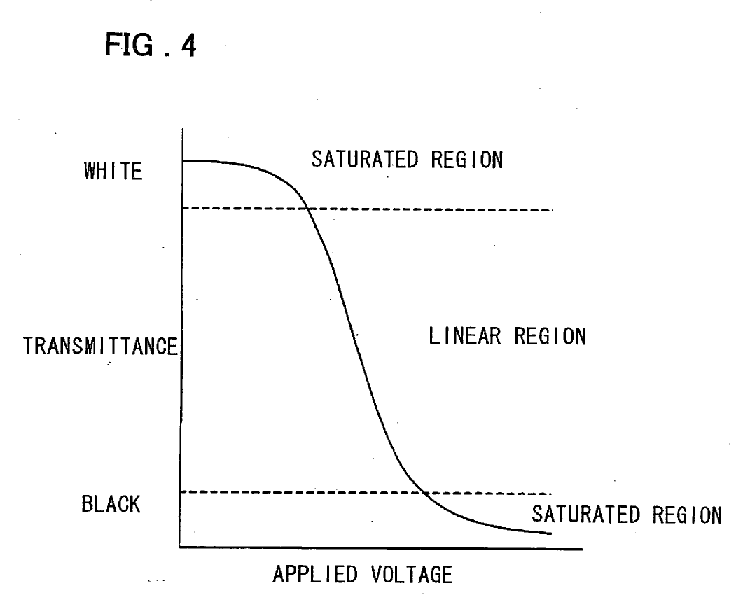

In the binary mode based upon the power-conservation signal, a black display is presented if the most significant bit of the digital image signal is “0”, and a white display is presented if the most significant bit is “1”, using saturated regions of a liquid crystal transmittance—voltage characteristic (referred to as a “V-T characteristic” below) illustrated in FIG. 4. This is the case for a normally white liquid crystal in which transmittance is maximum in the absence of applied voltage and minimum when maximum voltage is applied. Further, though this illustrates an example in which the digital image signal expresses 64 gray levels by six bits, the number of bits of the digital image signal may be five or less or seven or more.

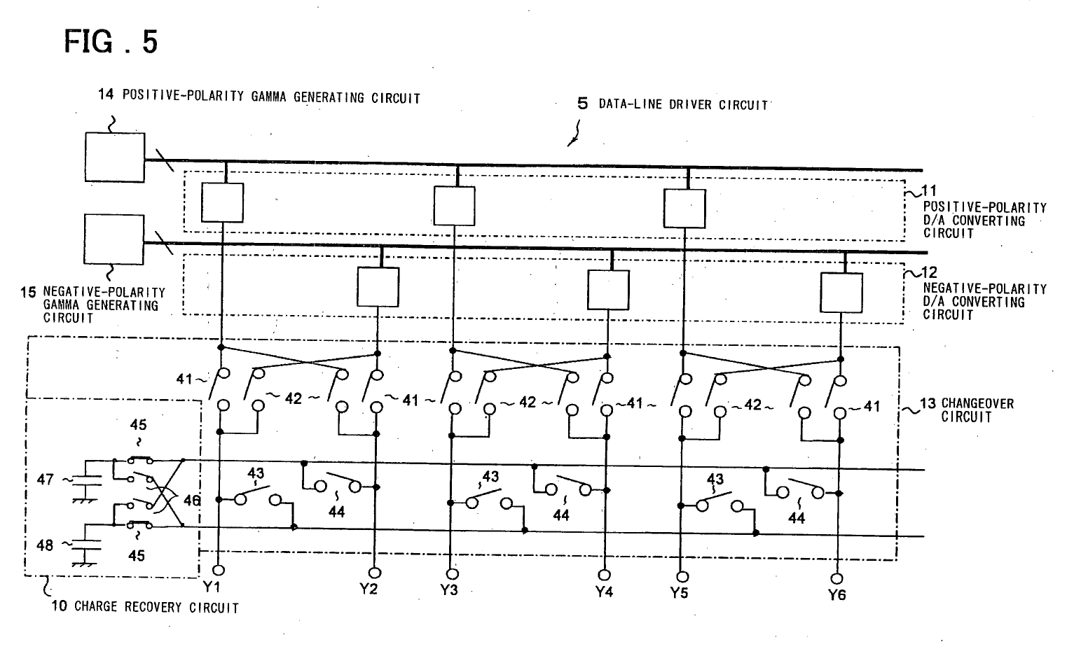

FIG. 5 is a circuit diagram illustrating part of the data-line driver circuit 5. The circuit includes a positive-polarity gamma generating circuit 14; a positive-polarity D/A (digital/analog) converting circuit 11 connected to the circuit 14; a negative-polarity gamma generating circuit 15; a negative-polarity D/A (digital/analog) converting circuit 12 connected to the circuit 15; and a changeover circuit 13 for selecting signals that are output from the positive-polarity D/A converting circuit 11 and negative-polarity D/A converting circuit 12, thereby driving data lines Y1, Y2, . . . . The changeover circuit 13 is provided with a charge recovery circuit 10.

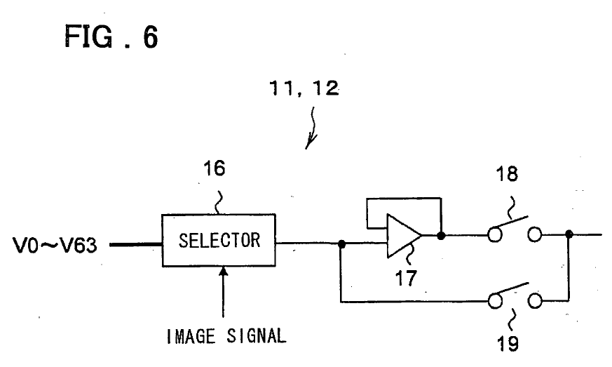

FIG. 6 is a circuit diagram illustrating the basic structure of the positive-polarity D/A converting circuit 11 and negative-polarity D/A converting circuit 12. One voltage is selected from among voltages of 64 values (V0 to V63) by a selector 16 in accordance with the digital image signal, and switches 18, 19 are turned on and off, respectively, in a first drive time period to drive a data line to a prescribed voltage at high speed by an amplifier 17. In a second drive time period, switches 18, 19 are turned off and on, respectively, to thereby apply a voltage, which has been selected by the selector 16, to the data line directly. In the second drive time period, the bias current of the amplifier 17 is cut off to thereby lower power consumption.

The vertical stripes that represent a drawback with V-line inversion drive can have two causes, namely a variance in the output voltage of the data-line driver circuit and pixel leakage current. A variance in the output voltage of the data-line driver circuit 5 is caused by a variance in the offset voltage of the amplifier 17. By applying the voltage selected by the selector 16 directly to the data line after the data line is driven by the amplifier 17 at high speed, the variance in output voltage is cancelled and, hence, image quality is improved. It should be noted that when the number of pixels of the liquid crystal display device is small, the amplifier 17 and switches 18, 19 may be deleted and the data line may driven directly by the voltage selected by the selector 16.

With regard to a D/A converting circuit that makes dot inversion drive possible, data lines are driven by selecting positive- and negative-polarity image signals in accordance with a digital image signal and polarity signal. To accomplish this, the positive- and negative-polarity D/A converting circuits 11 and 12, respectively, are provided and positive- or negative-polarity signals are selected by the changeover circuit 13 to thereby drive the data lines, as mentioned above. The changeover circuit 13 pairs odd-numbered data lines with even-numbered data lines and has switches 41, 42, 43 and 44 that perform a switching operation individually for each pair. Further, since dot inversion drive involves large consumption of power, the changeover circuit 13 is provided with the charge recovery circuit 10 in order to conserve power.

As illustrated in FIG. 5, the charge recovery circuit 10 includes a first capacitor 47, a second capacitor 48 and a pair of switches 45, 46. Either odd- and even-numbered data lines are shorted together or odd-numbered data lines are shorted together and connected to the first capacitor 47 and even-numbered data lines are shorted together and connected to the second capacitor 48, after which the connections of the first and second capacitors 47 and 48 are interchanged, thereby reducing power consumption.

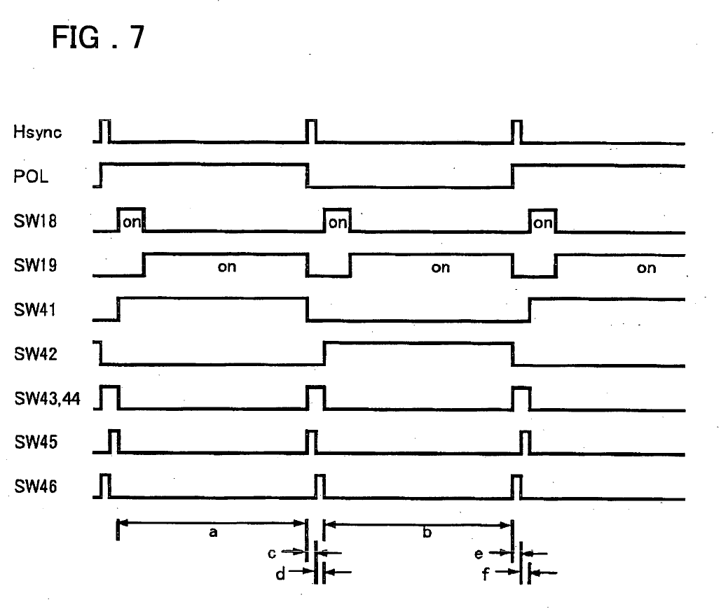

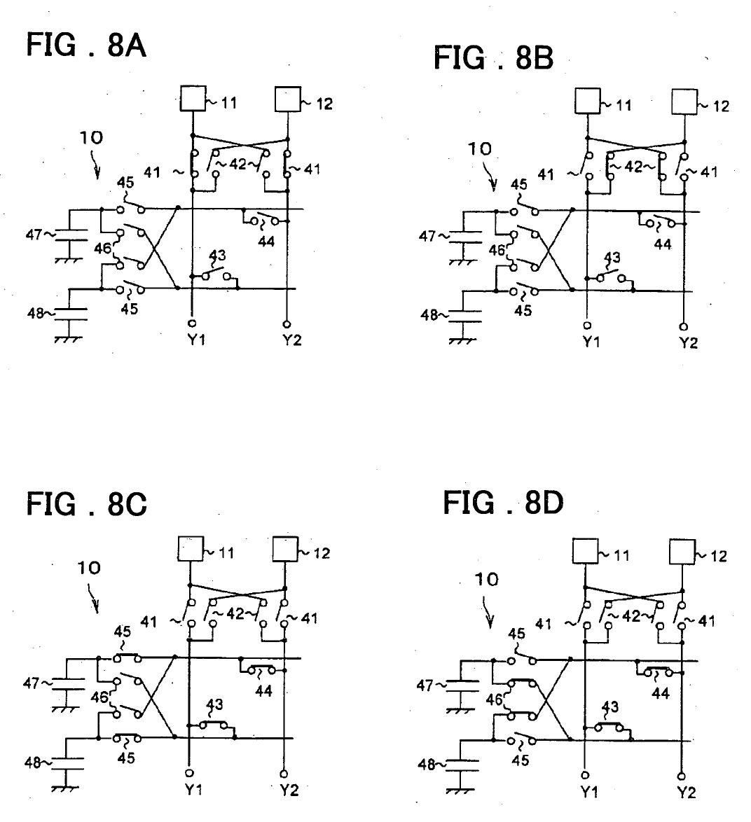

FIG. 7 is a timing chart and FIGS. 8A, 8B, 8C and 8D show a schematic diagram of the switching states of switches 41 to 46 in the changeover circuit 13. In FIG. 7, Hsync represents a horizontal synchronizing signal, POL a polarity signal and SW** the ON and OFF states of switches ** in the D/A converting circuits 11, 12 and changeover circuit 13.

In a time period a shown in FIG. 7, the polarity signal POL is at the high level, switches 41 are turned on and the other switches 42, 43, 44, 45 and 46 are turned off, as illustrated at FIG. 8A, thereby driving the odd-numbered data line by a positive-polarity signal and the even-numbered data line by a negative-polarity signal.

In a time period b shown in FIG. 7, the polarity signal POL is at the low level, switches 42 are turned on and the other switches 41, 43, 44, 45 and 46 are turned off, as illustrated at FIG. 8B, thereby driving the odd-numbered data line by a negative-polarity signal and the even-numbered data line by a positive-polarity signal.

In a time period c shown in FIG. 7, the switches 43, 44 and 45 are turned on and the other switches 41, 42 and 46 are turned off, as illustrated at FIG. 8C, thereby shorting all odd-numbered data lines together, averaging the voltages of each of the odd-numbered data lines and the voltage of the capacitor 48 and storing positive charge in capacitor 48, and similarly shorting all even-numbered data lines together, averaging the voltages of each of the even-numbered data lines and the voltage of the capacitor 47 and storing negative charge in capacitor 47.

In a time period d shown in FIG. 7, the switches 43, 44 and 46 are turned on and the other switches 41, 42 and 45 are turned off, as illustrated at FIG. 8D, thereby supplying the positive charge that has accumulated in capacitor 48 to the even-numbered data lines that were at negative polarity one scanning line earlier, and similarly supplying the negative charge that has accumulated in capacitor 47 to the odd-numbered data lines that were at positive polarity one scanning line earlier. Thus, the electric charge is caused to migrate.

In a time period e shown in FIG. 7, the switches 43, 44 and 46 are turned on and the other switches 41, 42 and 45 are turned off, as illustrated at FIG. 8D, thereby shorting all odd-numbered data lines together, averaging the voltages of each of the odd-numbered data lines and the voltage of the capacitor 47 and storing negative charge in capacitor 48, and similarly shorting all even-numbered data lines together, averaging the voltages of each of the even-numbered data lines and the voltage of the capacitor 48 and storing positive charge in capacitor 48.

In a time period f shown in FIG. 7, the switches 43, 44 and 45 are turned on and the other switches 41, 42 and 46 are turned off, as illustrated at FIG. 8C, thereby supplying the positive charge that has accumulated in capacitor 48 to the odd-numbered data lines that were at negative polarity one scanning line earlier, and similarly supplying the negative charge that has accumulated in capacitor 47 to the even-numbered data lines that were at positive polarity one scanning line earlier. Thus, the electric charge is caused to migrate.

The charge recovery described above is performed every scanning line in the case of dot inversion drive and every frame in the case of V-line inversion drive.

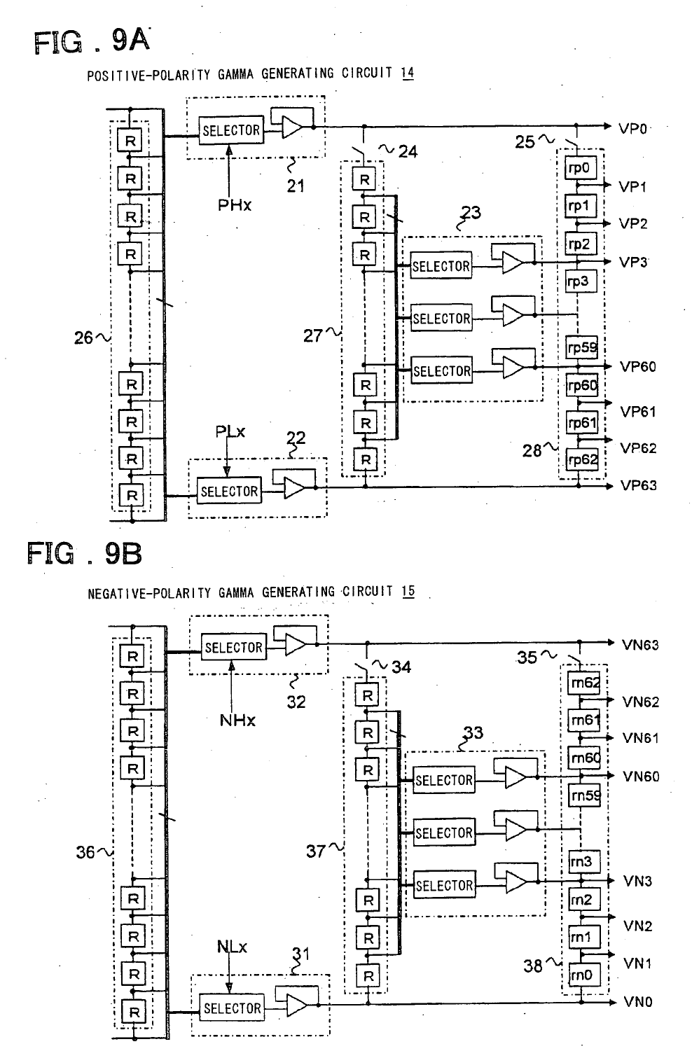

The positive-polarity gamma generating circuit 14 generates a plurality of positive-polarity grayscale voltages made to conform to a gamma characteristic beforehand, and the negative-polarity gamma generating circuit 15 generates a plurality of negative-polarity grayscale voltages made to conform to a gamma characteristic beforehand. FIG. 9A is a detailed diagram of the positive-polarity gamma generating circuit 14 and FIG. 9B is a detailed diagram of the negative-polarity gamma generating circuit 15. The positive-polarity gamma generating circuit 14 has a PHx register 21 comprising a D/A converting circuit for setting a positive-polarity black-level voltage value (VP0), and a PLx register 22 comprising a D/A converting circuit for setting a positive-polarity white-level voltage value (VP63). The negative-polarity gamma generating circuit 15 has an NLx register 31 comprising a D/A converting circuit for setting a negative-polarity black-level voltage value (VN0), and an NHx register 33 comprising a D/A converting circuit for setting a negative-polarity white-level voltage value (VN63). Contrast is adjusted by adjusting the registers. Further, other grayscale voltages are generated by resistor-string circuits 26, 36 in each of which a plurality of resistors are serially connected beforehand so as to conform to the gamma characteristic.

This embodiment provides resistor-string circuits 27, 37, 28, 38, which are selectively connected by switches 24, 34, 25, 35 so that the gamma characteristic can be finely adjusted, and D/A converting circuits 23, 33. With dot inversion drive in the normal display mode, switches 24, 25, 34, 35 are turned on to generate 64 grayscale voltages of positive polarity and 64 grayscale voltages of negative polarity. In the binary mode, switches 24, 25, 34, 35 are turned off to cut off the current that flows into resistor-string circuits 27, 37, 28, 38, thereby reducing power consumption.

With dot inversion drive in the normal display mode, drive is performed by inverting polarity every scanning line and therefore a large amount of power is consumed. However, with V-line inversion drive in the binary mode, power consumption is small in comparison with dot inversion drive. In a linear region (half-tone region) shown in FIG. 4, V-line inversion drive is disadvantageous in terms of vertical stripes and flicker. In saturated regions, however, there is almost no occurrence of vertical strips and flicker. The reason for this is as follows: Vertical stripes and flicker are produced by fluctuation of voltage that accumulates in pixels. In a saturated region, however, there is almost no effect upon transmittance even if voltage fluctuates and hence vertical stripes and flicker do not appear. In particular, if the level is the white level, difference with respect to the common electrode is small and the leakage current value also is small. As a consequence, vertical stripes and flicker do not appear.

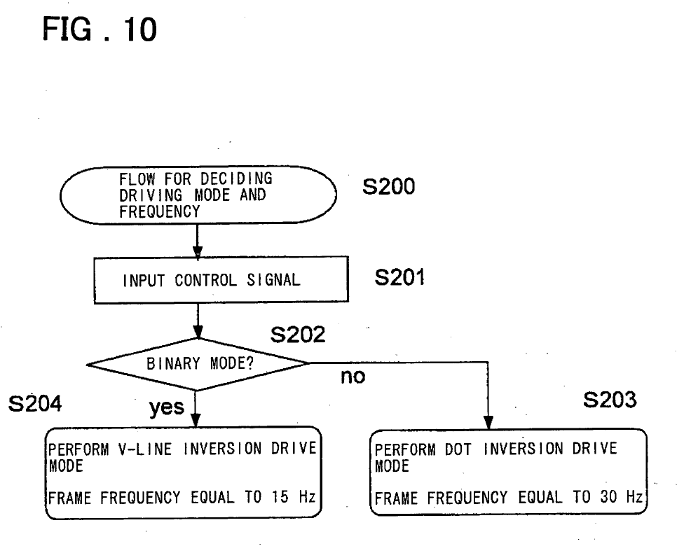

Thus, as set forth above, dot inversion drive is used in the normal display mode but V-line inversion drive is employed in the binary mode to make possible a large reduction in power consumption. Furthermore, in the binary mode, frame frequency may be lowered in comparison with the normal display mode. For example, as illustrated in the flowchart (S200) of FIG. 10 for deciding the driving mode and frequency, when a control signal is input to the device (S201), the control signal is discriminated (S202). If the mode is not the binary mode, i.e., if the effective mode is the normal display mode in which the power-conservation signal is absent, then dot inversion drive is performed and the frame frequency is made 30 Hz (S203). On the other hand, if the mode is the binary mode, then V-line inversion drive is performed and the frame frequency is made 15 Hz (S204). It is known that flicker tends to occur when frame frequency is lowered. However, with drive by a voltage in the saturated region, flicker does not appear and therefore no problems arise even if frame frequency is reduced. It goes without saying that frame frequency may be the same in the binary mode and normal display mode. If there are occasions where a clock signal is input from outside the liquid crystal display device, the device may be internally provided with an oscillator circuit and a signal that is not synchronized to the CPU signal may be generated. The frequency is lowered by a frequency diving circuit or the like.

### Second Embodiment

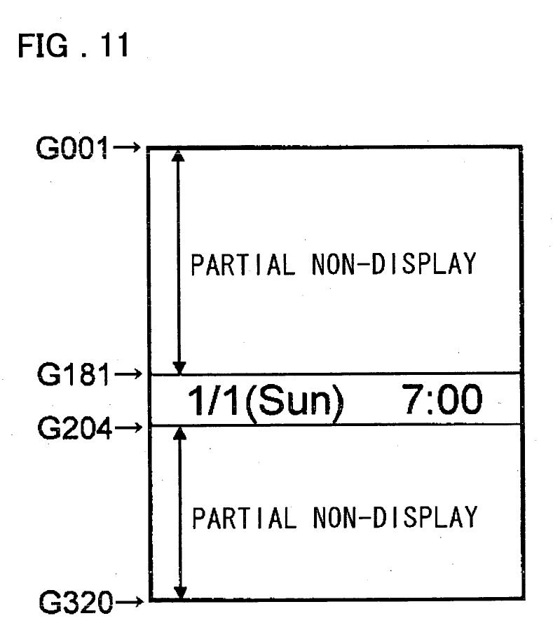

According to a second embodiment of the present invention, a drive method for conserving power during display of a standby screen involves implementing a partial display mode for presenting a display in a specific partial area of the kind shown in FIG. 11 and not presenting a display in other areas. In FIG. 11, an area G001 to G181 and an area G204 to G320 are areas in which a display is not presented on a standby screen. A partial display is presented on the standby screen only in an area from G181 to G204.

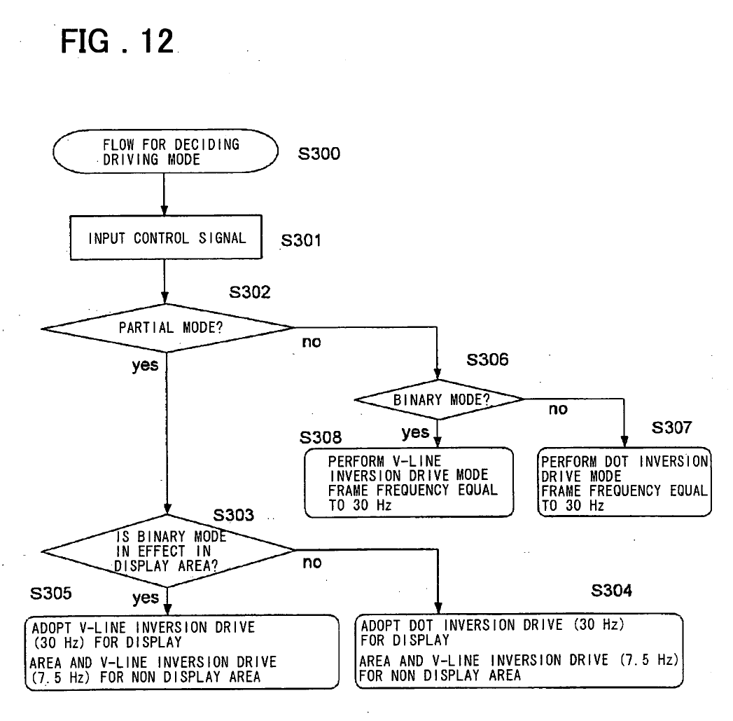

FIG. 12 illustrates a flowchart (S300) for deciding the driving mode according to the second embodiment. When the control signal is input to the device (S301), the control signal is discriminated (S302). If the mode is the partial mode, it is determined whether the binary mode is in effect (S303). With regard to the partial display area, dot inversion drive is performed (S304) in case of the 64-gray-level mode and V-line inversion drive is performed (S305) in case of the binary mode. Furthermore, with regard to the partial non-display areas, V-line inversion drive is performed in both modes to drive the scanning lines by interlaced scanning, whereby the frame frequency is lowered to make possible a reduction in power consumption (S304, S305). For example, the frame frequency is made 30 Hz in a display area. In a non-display area, scanning is performed once every four frames and the frequency is made 7.5 Hz.

On the other hand, if the decision rendered at step S302 is that the mode is not the partial mode, then, in a manner similar to that of the first embodiment, it is determined whether the mode is the binary mode (S306). In case of the normal display mode, dot inversion drive is performed (S307). In case of the binary mode, V-line inversion drive is used (S308). The frame frequency is made 30 Hz in either case.

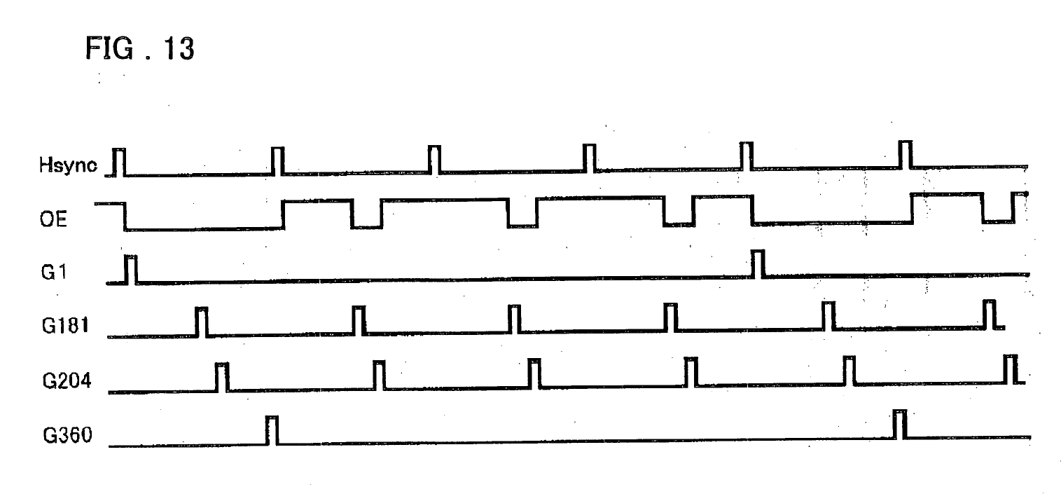

FIG. 13 is a timing chart of scanning-line drive in the partial mode. Here G181 to G204 represent a partial display area and therefore sequential scanning is performed. G001 to G180 and G205 to G320 represent interlaced scanning. Interlaced scanning is controlled by an output control signal OE of a scanning-line driver circuit. An OFF voltage is output if the OE signal is made an H-level signal, and an ON voltage is output if the OE signal is made an L-level signal. In a non-display area, therefore, scanning is performed in only one frame out of four, as illustrated in the timing chart of FIG. 13.

In order to reduce power consumption, it is preferred that a voltage approximately the same as the potential of the common electrodes of the liquid crystal be applied in the partial non-display area. In the partial non-display area, data lines and pixels are driven by absence of applied voltage in the saturated regions of the V-T characteristic of the liquid crystal shown in FIG. 4. In the case of a normally white liquid crystal, a partial non-display area presents a white display. Further, it is also possible to adopt a color other than white for a partial non-display area, and in the case of dot inversion drive, polarity can be changed every scanning line. When drive is performed at maximum applied voltage, therefore, the charge/discharge power of the parasitic capacitance of data lines and pixels increases. With V-line inversion, however, the pixel signal does not change in the case of a white raster display, etc., even with maximum applied voltage. Accordingly, though power is involved in the charge and discharge of pixels, no power is involved in the charge and discharge of data lines and power consumption can be reduced as a result. This means that a non-display area may be made any of seven colors (black, red, green, blue, cyan, magenta and yellow) other than white.

### Third Embodiment

Recent mobile telephones are not only used for voice conversation but also have various functions such as a camera function and TV telephone function. Often a moving image is supplied at the time of photography using the camera function, in TV reception, TV telephone and in games, etc., and still images are supplied at other times. Whether an image is a moving image or a still image can be selected and set by the user of the mobile telephone employing a menu screen or buttons. Not only is it possible to judge a change in an image as in Patent Document 1 but it is also possible to supply a movie-mode signal from the CPU 6 to the display control circuit 3 and reduce power consumption by this movie-mode signal.

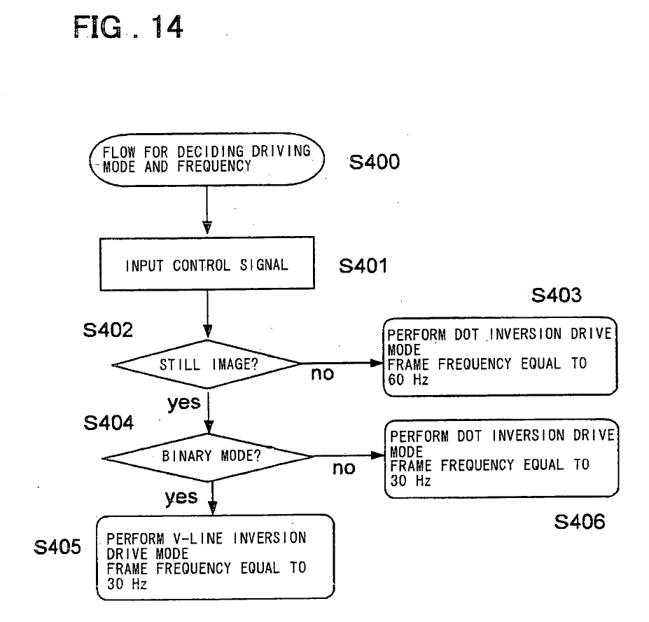

A third embodiment of the invention recognizes moving and still images to thereby reduce power consumption. FIG. 14 is a flowchart (S400) for deciding a driving mode and frequency. When the control signal is input to the device (S401), it is determined whether the signal contains a movie-mode signal or a still-image mode signal (S402). If the movie-mode signal is supplied, the frame frequency is raised to 60 Hz by dot inversion drive and a black display frame is inserted between display frames in such a manner that an after-image such as contour blurring will no longer appear (S403). If the movie-mode signal is not supplied, the mode becomes the still-image mode. In this case, as in the first and second embodiments, it is determined whether the control signal from the CPU 6 is the power-conservation signal, i.e., a signal indicative of the binary mode (S404). If the binary-mode signal is supplied, then the frame frequency is made 30 Hz by V-line inversion drive (S405). If the mode is not the binary mode, then the frame frequency is made 30 Hz by dot inversion drive in the normal display mode (S406). Accordingly, when the mode is the binary mode and the image is a still image, V-line inversion drive is performed and power can be conserved.

In the movie mode, interlaced drive may be adopted, even-numbered scanning lines are initially processing and then odd-numbered scanning lines are processed. A screen produced by the first scan is referred to as a “field”, and one screen (frame) is formed by two fields. In the case of the NTSC standard used in TV, 30 screen frames are displayed in one second and hence there are 60 fields per second.

### Fourth Embodiment

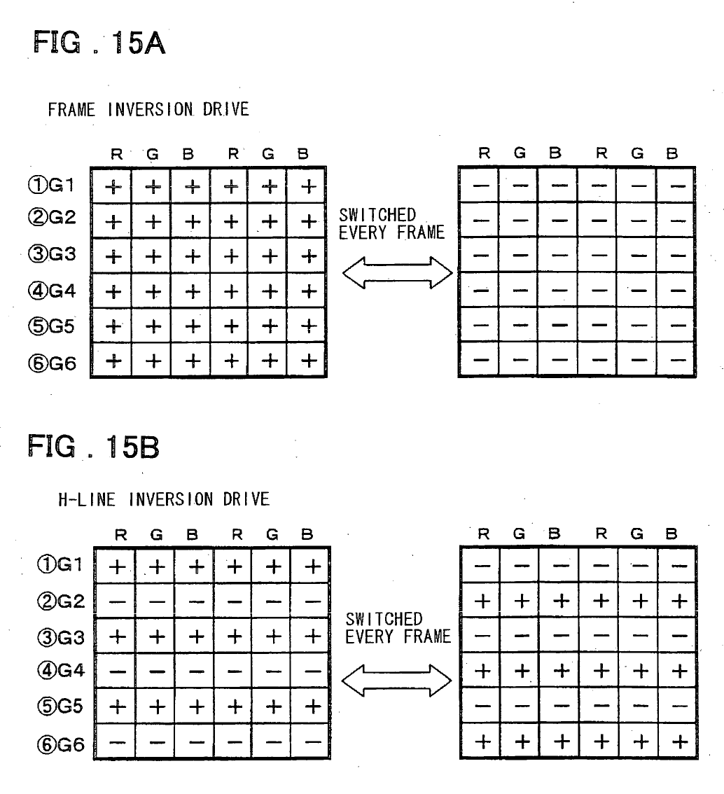

In the first to third embodiments, drive is switched between dot inversion and V-line inversion in accordance with the power-conservation signal from the CPU. However, H-line inversion drive may be substituted for dot inversion drive and frame inversion drive for V-line inversion drive, and drive may be switched between H-line inversion and frame inversion in accordance with the power-conservation signal or movie-mode signal. FIG. 15A is a diagram useful in describing frame inversion drive and FIG. 15B a diagram for describing H-line inversion drive. Frame inversion drive is a method of performing drive in such a manner that the polarity of a pixel differs from frame to frame. H-line inversion drive is a method of performing drive in such a manner that the polarities of neighboring pixels in the vertical direction differ from frame to frame.

The present invention is useful for portable electronic device such as mobile phones or the like. Also the embodiments are disclosed by way of the liquid crystal display device, the present invention may be applicable, with necessary modification of needed, to other type of display device based on the similar driving mechanism or principle.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A display device comprising:
pixels disposed at intersections of a plurality of scanning lines and a plurality of data lines; and
a circuit for changing at least one of driving mode and driving frequency in response to a power-conservation signal that is input when said device is in a mode different from a normal display mode.

2. The device according to claim 1, wherein the power-conservation signal is a signal indicative of a binary mode;
in the binary mode, one voltage is selected from binary voltages conforming to the most significant bit of an n-bit digital image signal and the data lines are driven according to a first driving mode; and
in the normal display mode, one voltage is selected from voltages of 2 n values conforming to all bits of the n-bit digital image signal and the data lines are driven according to a second driving mode.

3. The device according to claim 1, wherein the power-conservation signal is a signal indicative of a partial mode;
in a partial non-display area in the partial mode, the data lines are driven according to a first driving mode by an image-OFF voltage; and
in a partial display area in the partial mode, the data lines are driven according to the first driving mode when the binary mode is in effect, and one voltage is selected from voltages of 2 n values conforming to n bits of the digital image signal and the data lines are driven according to a second driving mode when the binary mode is not in effect.

4. The device according to claim 2, wherein the first driving mode is a V-line inversion driving mode, and the second driving mode is a dot inversion driving mode.

5. The device according to claim 2, wherein the first driving mode is a V-line inversion driving mode, the second driving mode is a dot inversion driving mode, and frame frequency in the first driving mode is set to be lower than frame frequency in the second driving mode.

6. The device according to claim 2, wherein the first driving mode is a frame inversion driving mode, and the second driving mode is an H-line inversion driving mode.

7. The device according to claim 1, wherein the power-conservation signal is input from a CPU of a portable electronic device such as a mobile telephone.

8. A driver circuit of a display device having pixels disposed at intersections of a plurality of scanning lines and a plurality of data lines, said circuit comprising:
a gamma generating circuit for generating a plurality of grayscale voltages by performing voltage division between a minimum applied voltage and a maximum applied voltage so as to conform to a gamma characteristic; and
a resistor-string circuit for generating a plurality of grayscale voltages other than the minimum applied voltage and maximum applied voltage of said gamma generating circuit;
wherein a value of current that flows into said resistor-string circuit can be changed in response to a power-conservation signal that is input when said device is in a mode different from a normal display mode.

9. The circuit according to claim 8, further comprising:
a positive-polarity D/A converting circuit for supplying a positive-polarity image signal to the data lines using a voltage of a liquid crystal common electrode as a reference, said voltage conforming to a digital image signal;
a negative-polarity D/A converting circuit for supplying a negative-polarity image signal to the data lines; and
a changeover circuit constituted by a plurality of switches for selecting the positive- or negative-polarity signal, and a capacitor; wherein in a first time period, a data line to which the positive-polarity image signal has been applied and one end of the capacitor are connected by turning on switches to thereby store an electric charge of positive polarity in the capacitor, and a data line to which the negative-polarity image signal has been applied and the other end of the capacitor are connected by turning on switches to thereby store an electric charge of negative polarity in the capacitor; and
in a second time period, terminals of said capacitor are interchanged.

10. The circuit according to claim 9, wherein the interchanging of said capacitor terminals is performed every frame at the time of V-line inversion drive and every n scanning lines at the time of n-dot inversion drive in accordance with a power-conservation signal that is input when the device is in a mode different from a normal display mode.

11. The circuit according to claim 8, wherein the power-conservation signal is input from a CPU of a portable electronic device and the display device comprises a liquid crystal display.

12. A method for driving a display device comprising:
providing a display device having pixels disposed at intersections of a plurality of scanning lines and a plurality of data lines; and
changing at least one of driving mode and driving frequency in response to a power-conservation signal that is input when said device is in a mode different from a normal display mode.

13. The method according to claim 12, wherein the power-conservation signal is a signal indicative of a binary mode;
in the binary mode, one voltage is selected from binary voltages conforming to the most significant bit of an n-bit digital image signal and the data lines are driven according to a first driving mode; and
in the normal display mode, one voltage is selected from voltages of 2 n values conforming to all bits of the n-bit digital image signal and the data lines are driven according to a second driving mode.

14. The method according to claim 12, wherein the power-conservation signal is a signal indicative of a partial mode;
in a partial non-display area in the partial mode, the data lines are driven according to a first driving mode by an image-OFF voltage; and
in a partial display area in the partial mode, the data lines are driven according to the first driving mode when the binary mode is in effect, and one voltage is selected from voltages of 2 n values conforming to n bits of the digital image signal and the data lines are driven according to a second driving mode when the binary mode is not in effect.

15. The method according to claim 13, wherein the first driving mode is a V-line inversion driving mode, and the second driving mode is a dot inversion driving mode.

16. The method according to claim 13, wherein the first driving mode is a V-line inversion driving mode, the second driving mode is a dot inversion driving mode, and frame frequency in the first driving mode is set to be lower than frame frequency in the second driving mode.

17. The method according to claim 13, wherein the first driving mode is a frame inversion driving mode, and the second driving mode is an H-line inversion driving mode.

18. The method according to claim 12, wherein the power-conservation signal is input from a CPU of a portable electronic device such as a mobile telephone.

19. A method for driving a driver circuit of a display device having pixels disposed at intersections of a plurality of scanning lines and a plurality of data lines, said method comprising the steps of:
a gamma generating steps for generating a plurality of grayscale voltages by performing voltage division between a minimum applied voltage and a maximum applied voltage so as to conform to a gamma characteristic; and
a gray scale voltage generating step using a resistor-string circuit, for generating a plurality of grayscale voltages other than the minimum applied voltage and maximum applied voltage of said gamma generating steps;
wherein a value of current that flows into said resistor-string circuit can be changed in response to a power-conservation signal that is input when said device is in a mode different from a normal display mode.

20. The method according to claim 19, further comprising:
a positive-polarity D/A converting step for supplying a positive-polarity image signal to the data lines using a voltage of a liquid crystal common electrode as a reference, said voltage conforming to a digital image signal;
a negative-polarity D/A converting step for supplying a negative-polarity image signal to the data lines; and
a changeover step, by switching a plurality of switches, for selecting the positive- or negative-polarity signal, and a capacitor; wherein
in a first time period, a data line to which the positive-polarity image signal has been applied and one end of the capacitor are connected by turning on switches to thereby store an electric charge of positive polarity in the capacitor, and a data line to which the negative-polarity image signal has been applied and the other end of the capacitor are connected by turning on switches to thereby store an electric charge of negative polarity in the capacitor; and
in a second time period, terminals of said capacitor are interchanged.

21. The method according to claim 20, wherein the interchanging of said capacitor terminals is performed every frame at the time of V-line inversion drive and every n scanning lines at the time of n-dot inversion drive in accordance with a power-conservation signal that is input when the device is in a mode different from a normal display mode.

22. The method according to claim 19, wherein the power-conservation signal is input from a CPU of a portable electronic device and the display device comprises a liquid crystal display.
